(19) United States
(12) Patent Application Publication
(10) Pub. No.: US 2025/0106753 A1
(43) Pub. Date: Mar. 27, 2025

(54) INFORMATION REPORTING METHOD AND USER EQUIPMENT

(71) Applicant: SHARP KABUSHIKI KAISHA, Sakai City, Osaka (JP)

(72) Inventors: NINGJUAN CHANG, Shanghai (CN); RENAMO LIU, Shanghai (CN)

(21) Appl. No.: 18/728,481

(22) PCT Filed: Jan. 16, 2023
(86) PCT No.: PCT/CN2023/072341

§ 371 Date: Jul. 12, 2024

(30) Foreign Application Priority Data
Jan. 17, 2022 (CN) 202210051652.2

(51) Int. Cl. H04W 48/20; H04W 48/08; H04W 74/0833

(52) U.S. Cl. CPC H04W 48/20; H04W 48/08; H04W 74/0833

(57) ABSTRACT

The present disclosure provides an information reporting method and user equipment. The information reporting method includes: a user equipment (UE) configured with dual connectivity (DC) successfully completing a primary secondary cell group cell (PSCell) change procedure, and triggering the recording of a PSCell change report (SPCR) to store SPCR information; and the UE including primary cell (PCell) information in the stored SPCR information, wherein the PCell information is information of a primary cell (PCell) associated before the UE performs reconfiguration with sync for the PSCell upon receiving a PSCell change command.

### TECHNICAL FIELD

The present disclosure relates to the technical field of wireless communications. More specifically, the present disclosure relates to a method for reporting information related to a primary secondary cell group cell in the case of dual connectivity, and corresponding user equipment.

### BACKGROUND

At the 3rd Generation Partnership Project (3GPP) RAN #94e plenary meeting held in December 2021, a new study item on Release 18 technology standards was approved (see Non-Patent Document: RP-213553: New WID on further enhancement of data collection for Self-Organizing Networks (SON)/Minimization of Drive Tests (MDT) in NR and EN-DC). The research objective of this item is to further enhance a network data collection procedure in an NR system based on Release 17 so as to better achieve the objective of a self-organization, self-optimization network and minimization of drive tests. One of the specific technologies studied is to implement information reporting in a scenario in which a primary secondary cell group cell (PSCell) is successfully changed.

The present disclosure provides a solution to the problem of how to implement PSCell information reporting in an NR system.

### SUMMARY

The objective of embodiments of the present disclosure is to provide a solution to the problem of how to implement PSCell information reporting in an NR system. More specifically, the present disclosure provides a solution to the problem of how to record PSCell change information after a PSCell change procedure is successfully performed when UE is configured with dual connectivity (DC) in an NR system. Embodiments of the present disclosure provide an information reporting method performed by user equipment and corresponding user equipment.

According to a first aspect of the present disclosure, provided is an information reporting method, comprising: a user equipment (UE) configured with dual connectivity (DC) successfully completing a primary secondary cell group cell (PSCell) change procedure, and triggering the recording of a PSCell change report (SPCR) to store SPCR information; and the UE including primary cell (PCell) information in the stored SPCR information, wherein the PCell information is information of a primary cell (PCell) associated before the UE performs reconfiguration with sync for the PSCell upon receiving a PSCell change command.

In the information reporting method according to the first aspect, the UE triggers the recording of the SPCR when a configured SPCR triggering condition is satisfied, and the SPCR triggering condition comprises any one of a T310 threshold for the PSCell, a T312 threshold for the PSCell, and a T304 threshold for a secondary cell group (SCG).

In the information reporting method according to the first aspect, the PCell information may comprise at least one of a cell identity, an absolute radio frequency channel number (ARFCN), a global cell identity (GCI), and a tracking area code (TAC) corresponding to the PCell.

In the information reporting method according to the first aspect, when the PSCell change command is received by means of a signaling radio bearer SRB1, the UE includes the PCell information in the stored SPCR information.

In the information reporting method according to the first aspect, when the UE determines that the PSCell change procedure is initiated by a master node (MN), the UE includes the PCell information in the stored SPCR information, the UE determining, on the basis of first information received from a network side, whether the PSCell change procedure is initiated by the MN, and the first information indicating whether the PSCell change procedure is initiated by the MN.

In the information reporting method according to the first aspect, the UE determines, on the basis of second information received from a network side, whether to include the PCell information in the stored SPCR information, and the second information explicitly enables/instructs the UE to include the PCell information in corresponding SPCR information.

In the information reporting method according to the first aspect, the UE determines, on the basis of a corresponding SPCR configuration, whether to include the PCell information in the stored SPCR information.

In the information reporting method according to the first aspect, when the UE receives a UEInformationRequest message from a network side, content in the stored SPCR is included in a UEInformationResponse message, and the UEInformationResponse message is transmitted to the network side, wherein the UEInformationRequest message carries an instruction/request used to request the UE to report the stored SPCR.

According to a second aspect of the present disclosure, provided is a user equipment (UE), comprising: a processor; and a memory storing instructions, wherein the instructions, when run by the processor, perform the information reporting method described herein.

### BRIEF DESCRIPTION OF THE DRAWINGS

In order to understand the present disclosure and advantages thereof more fully, reference will now be made to the following description made in conjunction with the accompanying drawings.

FIG. 1 is a schematic flowchart showing an information reporting method according to Embodiment 1 of the present disclosure.

FIG. 2 is a schematic flowchart showing an information reporting method according to Embodiment 2 of the present disclosure.

FIG. 3 is a block diagram showing user equipment (UE) according to the present disclosure.

In the drawings, identical or similar structures are marked by identical or similar reference numerals.

### DETAILED DESCRIPTION

According to the following detailed description of exemplary embodiments of the present disclosure made in conjunction with the accompanying drawings, other aspects, advantages, and prominent features of the present disclosure will become apparent to those skilled in the art.

In the present disclosure, the terms “include” and “comprise” and derivatives thereof mean inclusion and not limitation. The term “or” has an inclusive meaning and means “and/or”.

In the present specification, the following various embodiments for describing the principles of the present disclosure are merely illustrative, and should not be interpreted in any way as limiting the scope of the disclosure. The following description with reference to the accompanying drawings is used to facilitate full understanding of the exemplary embodiments of the present disclosure defined by the claims and equivalents thereof. The following description includes a variety of specific details to facilitate understanding, but these details should be considered merely exemplary. Therefore, those of ordinary skill in the art should recognize that various changes and modifications may be made to the embodiments described herein without departing from the scope and spirit of the present disclosure. In addition, the description of the known function and structure is omitted for clarity and simplicity. In addition, the same reference numerals are used for similar functions and operations throughout the accompanying drawings.

A plurality of embodiments according to the present disclosure are specifically described below by using a Long Term Evolution (LTE)/NR mobile communication system and subsequent evolved versions thereof as an exemplary application environment. However, it is to be noted that the present disclosure is not limited to the following embodiments, but is applicable to other wireless communications systems. If not otherwise specified, the concept of a cell and the concept of a base station are interchangeable in the present disclosure. An LTE system may also refer to a 5G LTE system and a post-5G LTE system (such as an LTE system referred to as an eLTE system or an LTE system that can be connected to a 5G core network). In addition, the LTE can be replaced with an evolved universal terrestrial radio access (E-UTRA) or an evolved universal terrestrial radio access network (E-UTRAN). In the present disclosure, a PSCell change refers to a primary secondary cell group cell change initiated by a network side, the change including an inter-cell primary secondary cell group cell change and an intra-cell primary secondary cell group cell change. That is, a PSCell of a UE is changed from a source PSCell to a target PSCell, wherein the source PSCell and the target PSCell may be the same cell or different cells. In this procedure, a security key or a security algorithm for access stratum security may or may not be updated accordingly. The security includes encryption and decryption and integrity protection. The source PSCell may also be referred to as a source secondary node, a source secondary cell group (SCG), a source beam, a source transmission point (TRP), or a source cell. The target PSCell may also be referred to as a target secondary node, a target beam, a target transmission point, a target secondary cell group (SCG), or a target cell. The PSCell change command described in the present disclosure is used to trigger the UE to perform a PSCell change. In an NR system, the PSCell change command is an RRC reconfiguration message including a reconfiguration with sync (Reconfigurationwithsync) information element, or rather, the PSCell change command is an RRC reconfiguration message including a reconfiguration with sync (Reconfigurationwithsync) information element for an SCG. At which time, the PSCell change may also be referred to as a reconfiguration with sync for an SCG or a reconfiguration with sync for a PSCell. The reconfiguration with sync information element may include configuration information of the target cell, for example, a target cell identifier, a target cell frequency, common configurations of the target cell such as system information, a random access configuration used by the UE to access the target cell, a security parameter configuration of the UE in the target cell, a radio bearer configuration of the UE in the target cell, and the like. For ease of description, in the present disclosure, a cell change command is equivalent to an RRC message including a cell change command, and refers to an RRC message or a configuration in an RRC message that triggers a UE to perform a cell change. A cell change configuration refers to all of or part of configurations in the cell change command. “Cancel”, “release”, “delete”, “clear”, and “remove” are interchangeable. “Execute”, “use”, and “apply” are interchangeable. “Configure” and “reconfigure” are interchangeable. “Monitor” and “detect” are interchangeable. A cell change refers to a PSCell change, if not otherwise specified.

The following describes processes or concepts in the prior art to which the present disclosure relates.

### Cell Change Configuration in NR System:

In an NR system, an RRC reconfiguration message for a cell change command carries RRC configurations from a target base station, including but not limited to the following RRC configurations (see Section 6.2.2 of 3GPP Technical Standard Protocol 38.331 for details):
A measurement configuration: used to configure intra-frequency, inter-frequency, and inter-radio access technology measurements performed by UE, for example, a measurement object configuration, a measurement report configuration, a measurement gap configuration, etc.
A cell group configuration (cellGroupConfig information element), used to configure a secondary cell group, including a Radio Link Control (RLC) bearer configuration (an rlc-bearerToAddModList information element and an rlc-bearerToreleaselist information element), a Medium Access Control (MAC) configuration (a MAC-cellgroupconfig information element), a physical layer configuration, a secondary cell addition/modification/release configuration, a special cell (SpCell) configuration, etc. corresponding to a data radio bearer/signaling radio bearer. The SpCell configuration includes a cell index number, cell change information (reconfiguration WithSync information element), a radio link failure-related timer and constant configuration, a Radio Link Monitoring (RLM) configuration, a special cell dedicated configuration, etc. The reconfigurationwithsync information element includes cell change related information such as serving cell configuration common information, a cell radio network temporary identifier (C-RNTI) of the UE in the target cell, configurations of a cell change procedure monitoring timer T304, a random access dedicated configuration for a random access procedure to the target cell, etc.
A radio bearer configuration (radiobearerConfig information element), used to configure a Service Data Application Protocol layer (SDAP) and a Packet Data Convergence Protocol layer (PDCP) of a Data Radio Bearer (DRB) and/or a Signaling Radio Bearer (SRB).
Key update configuration.

### Dual Connectivity (DC):

In order to improve the data transmission efficiency of the UE, the UE simultaneously establishes links with two base stations. That is, radio resources used by the UE are provided by different schedulers located in the two base stations. Radio access between the two base stations and the UE may be the same or different Radio Access Technology (RAT). For example, both are NR, or one is NR, and one is LTE, also referred to as evolved universal terrestrial radio access (E-UTRA). In these two base stations, one is referred to as a master node (MN) or an MgNB or an MeNB. A serving cell group under the master node is referred to as a master cell group (MCG). The other is referred to as a secondary node (SN) or an SgNB or an SeNB, and a serving cell group under the secondary node is referred to as a secondary cell group (SCG). When the master node is LTE and the secondary node is NR, DC is referred to as EN-DC (using a 4G core network) or NGEN-DC (using a 5G core network). When the master node and the secondary node are both NR, DC is referred to as NR-DC. An MCG includes one primary cell (PCell) and one or more optional secondary cells (SCells). The PCell operates on a primary frequency, and the UE performs an initial connection setup procedure or a connection re-establishment procedure by means of the primary frequency. An SCG includes one primary SCG cell (PSCell) and one or more optional SCells. The PSCell refers to an SCG cell that performs random access when the UE performs a reconfiguration with sync procedure for an SCG. The PCell and the PSCell are also collectively referred to as special cells (SpCells). When DC is configured, a DRB and an SRB for the UE are supported to be configured to be a split bearer. When not configured to be a split SRB, SRB1 and SRB2 are transmitted by means of an MCG path. Furthermore, when the DC is configured, SRB3 may also be set up for the SN to transmit configurations associated with the SCG between the SN and the UE, etc. Setup and release of SRB3 are both determined by the SN.

### PSCell Change Procedure in NR System:

A PSCell change may be initiated by an MN or an SN. The MN or the SN may initiate a PSCell change on the basis of a factor such as a measurement result of a source PSCell or a neighboring cell reported by a UE, or the load of a neighboring cell, or the like. In a PSCell change procedure in which the MN participates (no matter whether the PSCell change procedure is initiated by the MN or the SN), a cell change command for a PSCell is included in an RRC reconfiguration message of SRB1 and transmitted to the UE. A PSCell change command is an RRC reconfiguration message for an SCG. When the PSCell change command is transmitted to the UE by means of an MCG link, the PSCell change command is typically included in an mrdc-SecondaryCellGroupConfig information element or an nr-SecondaryCellGroupConfig information element, and is inserted in an RRC reconfiguration message of SRB1. If the PSCell change does not need participation of the MN, e.g., an intra-SN PSCell change scenario, then the SN may autonomously generate an RRC reconfiguration message of the PSCell change command, and transmit the same to the UE by means of SRB3 of an SCG link.

The UE receiving the PSCell change command applies immediately a configuration of the cell change command to perform a PSCell change, including a random access procedure to the PSCell. The UE monitors the cell change procedure by means of a timer T304. When the cell change procedure is initiated, the UE starts the T304 timer. When the cell change procedure is completed (the random access procedure is successfully completed), the UE stops the timer T304. When T304 expires, the UE considers that the PSCell change fails or reconfiguration with sync fails.

### Successful Handover Report:

Handover information reporting when a successful handover is introduced in an NR system of Release 17. Said handover refers to a PCell change or a reconfiguration with sync of a PCell. A handover command refers to an RRC reconfiguration message including a reconfiguration with sync information element for an MCG. The handover information reporting for a successful handover is also referred to as a successful handover report (SHR) for short. This is because, in an NR system, performing network optimization by relying only on a radio link failure (RLF) report in an existing mechanism may cause a data acquisition process to become lengthened, and handover information reporting, when a handover succeeds, enables the network side to acquire a sufficient number of samples in a mobility procedure more quickly. Second, even for a successful handover scenario, a mobility parameter thereof also needs to be further optimized. Content of an SHR may include one or more of the following: a source cell identity of a handover; a target cell identity of the handover; a measurement result of a source cell or a target cell of the handover; a measurement result of a neighbor cell; and an indication indicating a reason that the SHR is triggered (i.e. which triggering condition is satisfied), etc. Success of the handover includes an RRC reconfiguration complete message for responding to a handover command RRC reconfiguration message with respect to the target base station being successfully transmitted, or a random access procedure to the target base station being successfully completed at a MAC layer. The network side needs to configure, to the UE, a triggering condition (e.g., thresholds corresponding to T310, T312, and T304) of the successful handover report. The UE records handover information of the successful handover only when the configured one or more triggering conditions are satisfied (e.g., a runtime value of T310 or T312 of the source cell exceeds the configured corresponding threshold when the handover command is received, and a runtime value of T304 exceeds the configured corresponding threshold when the handover is successfully completed). The triggering condition related to the source cell, e.g., the T310 threshold or the T312 threshold, is configured to the UE by the source cell, and the triggering condition related to the target cell, e.g., the T304 threshold, is configured to the UE by the target cell. The UE may inform, by using an RRC message, the network side that an available successful handover report (for example, indicated by a successHO-InfoAvailable information element) is present thereon. After receiving the indication, the network side may request, by using an RRC message (for example, indicated by successHO-ReportReq in a UEInformationRequest message), the UE to report the successful handover information report stored thereby. The UE reports the stored radio link failure report (successHO-Report in the UEInformationResponse message) to the network side in a response RRC message. The successful handover report stored on the UE may be stored for up to 48 hours.

As described above, the SHR mechanism when the PCell handover is standardized in the NR system of Release 17 to further optimize mobility robustness in the handover scenario. However, a study objective in Release 18 is to introduce a PSCell change report (successful PSCell change report, SPCR) in a PSCell change scenario. Information of a successful PSCell change procedure is reported to the network side, so that the network side can optimize and adjust a parameter of the PSCell change, so as to improve mobility robustness of the PSCell. In the present disclosure, it is assumed that a reporting procedure of the SPCR is similar to that of the SHR. That is, if UE that has successfully performed a PSCell change procedure determines that an SPCR needs to be generated, the UE stores, in a corresponding UE variable, content of the generated SPCR, and indicates, to the network side by means of an RRC message, that the stored SPCR is present thereon. Upon receiving a request from the network side for instructing the UE to report the SPCR, the UE includes the stored SPCR in an RRC message and reports the same to the network side. Different from the handover scenario, in the PSCell change scenario, in addition to the participation of the source PSCell and the target PSCell, in an SN modification procedure triggered by the MN or an SN change procedure triggered by the MN, the MN also participates in the procedure in addition to the participation of the source PSCell and the target PSCell. Therefore, in a network optimization procedure corresponding to a successful PSCell change report, whether to consider delivering an SPCR to an MN to cause the MN to participate in a mobility robustness optimization procedure of a PSCell has become a matter of concern to the present disclosure. Further, in consideration of the problem that the MN participates in mobility robustness optimization of the PSCell, how to enable the SPCR to be delivered to the MN and how a UE determines whether the SPCR needs to be delivered to the MN are matters of concern in the present disclosure. This is because, when the UE that generates the SPCR performs a PSCell change, if a PSCell change command is received by means of SRB1, the UE cannot know whether the PSCell change procedure is initiated by the MN or the SN.

The following embodiments provide a solution to the above problems. If not otherwise specified, the embodiments are not mutually exclusive, and may be combined, or some concepts or definitions are commonly applicable among the embodiments.

### Embodiment 1

This embodiment provides an information reporting method performed by UE. By means of the method described in this embodiment, a UE may determine, on the basis of indication information or an SPCR configuration received from a network side, whether to include PCell information in a successful PSCell change report (SPCR) to report the same to the network side. The UE includes the PCell information in the SPCR, so that a base station that retrieves the SPCR from the UE can deliver the SPCR to a corresponding PCell base station (i.e., the aforementioned MN) according to the PCell information carried in the SPCR. The MN may adjust and optimize a PSCell change parameter on the basis of the information in the received SPCR. In addition, the UE determines, on the basis of the indication information or the SPCR configuration received from the network side, whether to include the PCell information in the successful PSCell change report (SPCR) to report the same to the network side, thereby avoiding unnecessary signaling overhead caused by the UE always including the PCell information in the SPCR.

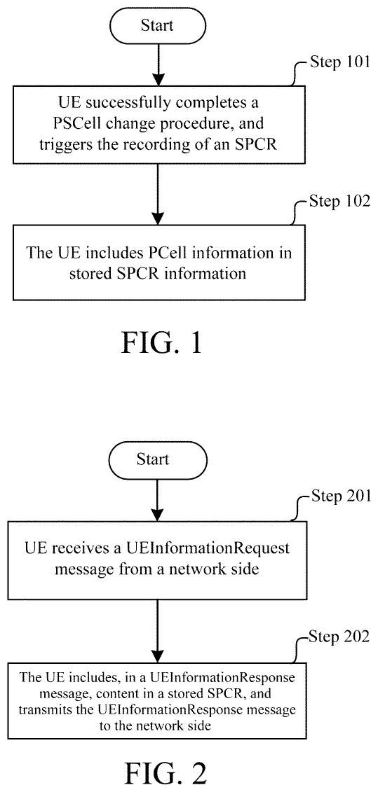

Embodiment 1 of the present disclosure will be described in detail below. FIG. 1 is a schematic flowchart showing an information reporting method according to Embodiment 1 of the present disclosure. As shown in FIG. 1, the information reporting method according to Embodiment 1 of the present disclosure may include the following steps.

Step 101: upon successful completion of a PSCell change procedure, triggering, by UE, the recording of an SPCR, i.e., determining, by the UE, that SPCR information corresponding to the PSCell change procedure is stored in a corresponding UE variable.

The successful completion of a PSCell change procedure generally means that a random access procedure triggered for a reconfiguration with sync procedure for a PSCell/SCG is successfully completed, or a response message, i.e., an RRC reconfiguration complete message, for responding to a PSCell change command, i.e., an RRC reconfiguration message including reconfiguration with sync for the SCG, has been transmitted.

Optionally, the UE triggers the recording of the SPCR, and similar to the SHR mechanism in Release 17, the UE triggers the recording of the SPCR when a configured SPCR triggering condition is satisfied. That is, the UE determines, according to whether a triggering condition in an SPCR configuration is satisfied, whether to store the SPCR information corresponding to the procedure. The triggering condition may be a T310 threshold for the PSCell, a T312 threshold for the PSCell, or a T304 threshold for the SCG. In one means, the threshold is a percentage threshold. For example, when the ratio of a runtime value of T310 of a source PSCell before the UE performs reconfiguration with sync for the PSCell upon receiving a PSCell change command to a configured value of T310 exceeds the configured threshold, the UE determines to store the SPCR information corresponding to the procedure.

Step 102: including, by the UE, PCell information thereof in the stored SPCR information.

The PCell refers to a primary cell associated before the UE performs reconfiguration with sync for the PSCell upon receiving a PSCell change command. Preferably, the PCell information is a cell identity corresponding to the PCell, e.g., one or more of a physical cell identity (PCI), an absolute radio frequency channel number (ARFCN), a global cell identity (GCI), and a tracking area code (TAC). Alternatively, the PCell information further includes a measurement result of the PCell, i.e., information for representing downlink signal quality of the PCell. Optionally, the measurement result is a latest measurement result acquired before the UE performs reconfiguration with sync for the PSCell upon receiving a PSCell change command.

Optionally, in implementation means 1, when the PSCell change command is received by means of SRB1, the UE includes the PCell information thereof in the stored SPCR information. Optionally, the PSCell change command being received by means of SRB1 means that the RRC reconfiguration message of reconfiguration with sync for the PSCell is included in mrdc-SecondaryCellGroup, and is received by means of SRB1. In this implementation means, when the PSCell change command is received by means of SRB3, the UE does not include the PCell information thereof in the stored SPCR information.

Optionally, in implementation means 2, when the UE determines that the PSCell change procedure is initiated by an MN, the UE includes the corresponding PCell information in the stored SPCR information. The UE determines, on the basis of first information received from a network side, whether the PSCell change procedure is initiated by the MN. The first information indicates whether the PSCell change procedure is initiated by the MN. For example, if the first information is configured to MN, the UE considers that the PSCell change procedure is initiated by the MN. The first information may be included in a corresponding PSCell change command, or may be included in an outer layer RRC reconfiguration message of a PSCell change command. That is, the MN configures the first information, and includes the same in the RRC reconfiguration message.

Optionally, in implementation means 3, the UE determines, on the basis of second information from the network side, whether to include the corresponding PCell information in the stored SPCR information. That is, the UE receives the second information from the network side, and the second information explicitly enables/instructs the UE to include the PCell information in corresponding SPCR information. The second information may be included in a corresponding PSCell change command so as to be configured to the UE, or may be included in an outer layer RRC reconfiguration message of a PSCell change command. That is, the MN configures the first information, and includes the same in the RRC reconfiguration message.

Optionally, in implementation means 4, the UE determines, on the basis of a corresponding SPCR configuration, whether to include the corresponding PCell information in the stored SPCR information. In this implementation means, both the MN and an SN may configure the SPCR configuration of the UE. Optionally, if only one of the MN and the SN configures the SPCR configuration for the UE, and if the UE determines, when generating an SPCR, that the corresponding SPCR configuration is configured by the MN, the UE includes the corresponding PCell information in the SPCR. Otherwise, if the corresponding SPCR configuration is configured by the SN, the UE does not include the corresponding PCell information in the SPCR. Optionally, if the UE determines, when generating an SPCR, that an SPCR configuration corresponding to a triggering reason of triggering the SPCR is configured by the MN, the UE includes the corresponding PCell information in the SPCR. This is mainly due to consideration of the case in which the MN and the SN both configure the SPCR configuration for the UE at the same time. For example, different T310 thresholds (TH1 configured by the MN and TH2 configured by the SN) are configured, so that if the UE determines that the recording of the SPCR is triggered due to that the ratio of the runtime value of T310 to the configured value thereof exceeds the threshold TH1, the UE includes the corresponding PCell information in the SPCR because TH1 is configured by the MN. Optionally, the UE further includes, in an SPCR message, information for indicating a triggering reason of the SPCR and whether a triggering condition/SPCR configuration corresponding to the triggering reason is configured by the MN or the SN.

Optionally, the outer layer RRC message may also be an RRC resume message.

Optionally, the first information and the second information may not be transmitted to the UE together with the PSCell change command, that is, may be transmitted to the UE by means of another RRC message preceding the PSCell change command.

Obviously, before step 101, the method further includes: receiving, by the UE, a PSCell change command from the network side, and applying the command to perform reconfiguration with sync to the PSCell.

Optionally, this embodiment is also applicable to the case of PSCell addition. That is, the PSCell change may also be PSCell addition.

Optionally, this embodiment is also applicable to the case of a conditional PSCell change (CPC), also referred to as conditional reconfiguration for the SCG.

### Embodiment 2

This embodiment provides a PSCell change information reporting method performed by UE. By means of the method described in this embodiment, a UE can report, in an SPCR, relevant information to a base station, so as to provide, to a network side, PSCell change information that is more accurate. This embodiment provides a method for signaling flow when a UE reports the information report in Embodiment 1 by means of an RRC procedure.

Embodiment 2 of the present disclosure will be described in detail below. FIG. 2 is a schematic flowchart showing an information reporting method according to Embodiment 2 of the present disclosure. As shown in FIG. 2, the information reporting method according to Embodiment 2 of the present disclosure may include the following steps.

Step 201: receiving, by a UE, a UEInformationRequest message from a network side, the UEInformationRequest message carrying an instruction/request for requesting the UE to report a stored SPCR.

Step 202: including, by the UE in a UEInformationResponse message, content in the stored SPCR, and transmitting the UEInformationResponse message to the network side. The SPCR report included in the UEInformationResponse message includes the PCell related information in Embodiment 1.

### Embodiment 3

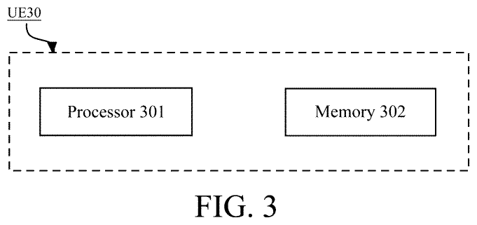

In this example, user equipment (UE) according to the present disclosure is described. FIG. 3 shows a block diagram of a user equipment (UE) according to the present invention. As shown in FIG. 3, user equipment (UE) 30 includes a processor 301 and a memory 302. The processor 301 may include, for example, a microprocessor, a microcontroller, an embedded processor, and the like. The memory 302 may include, for example, a volatile memory (such as a random access memory (RAM)), a hard disk drive (HDD), a non-volatile memory (such as a flash memory), or other memories, etc. The memory 302 has program instructions stored thereon. When run by the processor 301, the instructions can perform the above information reporting method described in detail in the present invention.

The methods and related devices according to the present disclosure have been described above in conjunction with preferred embodiments. It should be understood by those skilled in the art that the methods shown above are only exemplary. The method according to the present disclosure is not limited to steps or sequences shown above. The base station and user equipment shown above may include more modules. For example, the base station and user equipment may further include modules that may be developed or will be developed in the future to be applied to a base station, an MME, or UE. Various identifiers shown above are only exemplary, not for limitation, and the present disclosure is not limited to specific information elements serving as examples of these identifiers. A person skilled in the art could make various alterations and modifications according to the teachings of the illustrated embodiments.

The program running on the device according to the present disclosure may be a program that enables a computer to implement the functions of the embodiments of the present disclosure by controlling a central processing unit (CPU). The program or information processed by the program may be temporarily stored in a volatile memory (for example, a random access memory (RAM)), a hard disk drive (HDD), a non-volatile memory (for example, a flash memory), or other memory systems.

The program for implementing the functions of the embodiments of the present disclosure may be recorded on a computer-readable recording medium. The corresponding functions may be achieved by reading programs recorded on the recording medium and executing the programs by a computer system. The phrase “computer system” herein may be a computer system embedded in the device, which may include operating systems or hardware (e.g., peripherals). The phrase “computer-readable recording medium” may refer to a semiconductor recording medium, an optical recording medium, a magnetic recording medium, a recording medium for programs that are dynamically stored for a short time, or any other recording medium readable by a computer.

Various features or functional modules of the device used in the above embodiments may be implemented or executed by circuits (for example, monolithic or multi-chip integrated circuits). Circuits designed to execute the functions described in this description may include general-purpose processors, digital signal processors (DSPs), application-specific integrated circuits (ASICs), field-programmable gate arrays (FPGAs) or other programmable logic devices, discrete gates or transistor logic, or discrete hardware components, or any combination of the above. The general-purpose processor may be a microprocessor, or may be any existing processor, controller, microcontroller, or state machine. The circuit may be a digital circuit or an analog circuit. When new integrated circuit technologies that replace existing integrated circuits emerge because of the advances in semiconductor technology, one or a plurality of embodiments of the present disclosure may also be implemented using these new integrated circuit technologies.

Furthermore, the present disclosure is not limited to the embodiments described above. Although various examples of the described embodiments have been described, the present disclosure is not limited thereto. Fixed or non-mobile electronic devices installed indoors or outdoors, such as AV equipment, kitchen equipment, cleaning equipment, air conditioners, office equipment, vending machines, and other household appliances, may be used as terminal devices or communications devices.

The embodiments of the present disclosure have been described in detail above with reference to the accompanying drawings. However, the specific structures are not limited to the above embodiments. The present disclosure also includes any design modifications that do not depart from the substance of the present disclosure. In addition, various modifications may be made to the present disclosure within the scope of the claims. Embodiments resulted from the appropriate combinations of the technical means disclosed in different embodiments are also included within the technical scope of the present disclosure. In addition, components with the same effect described in the above embodiments may be replaced with one another.

1. A method performed by a user equipment, the method comprising the following steps:
executing a reconfiguration with sync for a primary secondary cell group cell (PSCell) upon receiving an radio resource control (RRC) Reconfiguration message including reconfigurationwithsync for the PSCell,
successfully completing a random access procedure triggered for the reconfiguration with Sync for the PSCell,
storing a successful PSCell change report information in a UE variable wherein,
the successful PSCell change report information include an primary cell (PCell) information in the successful PSCell change report.

2-8. (canceled)

9. A user equipment (UE), comprising:
a processor, configured to:
execute a reconfiguration with sync for a primary secondary cell group cell (PSCell) upon receiving a radio resource control (RRC) Reconfiguration message including reconfigurationwithsync for the PSCell,
successfully complete a random access procedure triggered for the reconfiguration with Sync for the PSCell; and
store a successful PSCell change report information in a UE variable, wherein
the successful PSCell change report information include a primary cell (PCell) information.

10. The UE according to claim 1, wherein
the PCell information is global cell identity and tracking area code of the PCell.
